(19) United States
(12) Patent Application Publication
(10) Pub. No.: US 2010/0049597 A1
(43) Pub. Date: Feb. 25, 2010

(54) SUPERVISED VOTING SYSTEM AND METHOD

(75) Inventor: Craig Alexander Burton, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: EVERYONE COUNTS, INC., San Diego, CA (US)

(21) Appl. No.: 12/597,717

(22) PCT Filed: Apr. 25, 2008
(86) PCT No.: PCT/IB08/01038

§ 371 Date: Oct. 26, 2009

(30) Foreign Application Priority Data
Apr. 25, 2007 (GB) 0708029.4
Dec. 10, 2007 (GB) 0723998.1

(51) Int. Cl. G07C 13/00; G06Q 10/00

(52) U.S. Cl. 705/12

(57) ABSTRACT

The invention provides a supervised voting method for allowing a voter to vote under the supervision of a supervisor at a voting booth at which the voter can vote. The method comprises the voter providing identity information to the supervisor, the supervisor verifying the identity of the voter and sending the identity information to a remote polling administrator service, which determines voter specific voting options to be presented to that voter. The method further comprises the polling administrator service sending details of the voter-specific voting options to the voting booth, the voting booth displaying the voting options to the voter, voting booth receiving voting information from the voter, and the voting booth sending the voting information to a vote processor.

This invention relates to a supervised voting system and in particular an electronic voting system. It also relates to a method of operation of the voting system.

Voting systems can be used to count, store and/or register the number of votes received by each eligible elector. Such voting systems are useful in many different fields such as local or national government elections, media driven voting in response to a television programme, for example, or for entertainment, such as a poll, “e-consultation”, plebiscite, deliberative ballot, party pre-selection poll, non-government, organisational, union election, referenda or other democratic process. It will be appreciated that the invention described herein may be applicable in many fields, although in this application the description will focus on voting systems used for political elections and the like.

It is common for votes to be made on a paper ballot at a voting or polling station (a particular building or room in a building). The paper ballots are typically received in a secure box by officials at the supervised voting station and, once the period for placing votes has expired, the secure box is transported by officials or police to a central counting station so that the votes can be counted and the totals compiled with the results from other polling stations. This vote-casting process is well known as the secret ballot.

Electronic based voting systems are known and comprise a standalone voting terminal that has software loaded thereon. The terminal is programmed such that it presents the voter with the list of candidates for the particular region, borough or ward that the terminal is located in, so that the voter can cast their vote. In operation, a person wanting to vote would arrive at the polling station and proceed to the electoral role officer, who determines whether or not that person is eligible to vote. Such e-voting stations typically use a paper version of the electoral register or an electronic register with a database installed on the terminal the presiding officer uses.

If the voter is eligible, the officer issues the voter with an electronic card or other token that will activate one of the voting terminals. The voter can then proceed to the terminal, insert the electronic card or token, which will cause a list of candidates to be presented, and place their vote. The vote is stored in the voting terminal or on a removable storage medium in the voting terminal. The standalone terminals or their storage media are collected from the polling station and transported to a counting station for compiling the results from each terminal. However, there are several disadvantages with this arrangement as there is the possibility that the terminals could be reprogrammed to alter the votes that have been cast. Further, the standalone machines or their removable storage media (e.g. memory cards) could be stolen, altered, lost or damaged while being transported to the counting station thereby discounting all of the votes placed on that machine/distorting the results of the election.

Voting via the Internet is also known. This arrangement typically comprises a voter being provided with an identifier, such as a secret unique PIN number, by post. The voter then visits a voting website which requires entry of the PIN number. Following PIN verification the user can register a vote. Voting via the Internet can pose security risks since the voter's terminal may have low security—it may be compromised or remotely observed. Public confidence in Internet voting is generally low due to the possibility of Internet fraud perpetrated via techniques such as “phishing”.

There now follows by way of example only a detailed description of the present invention with reference to the accompanying drawings in which;

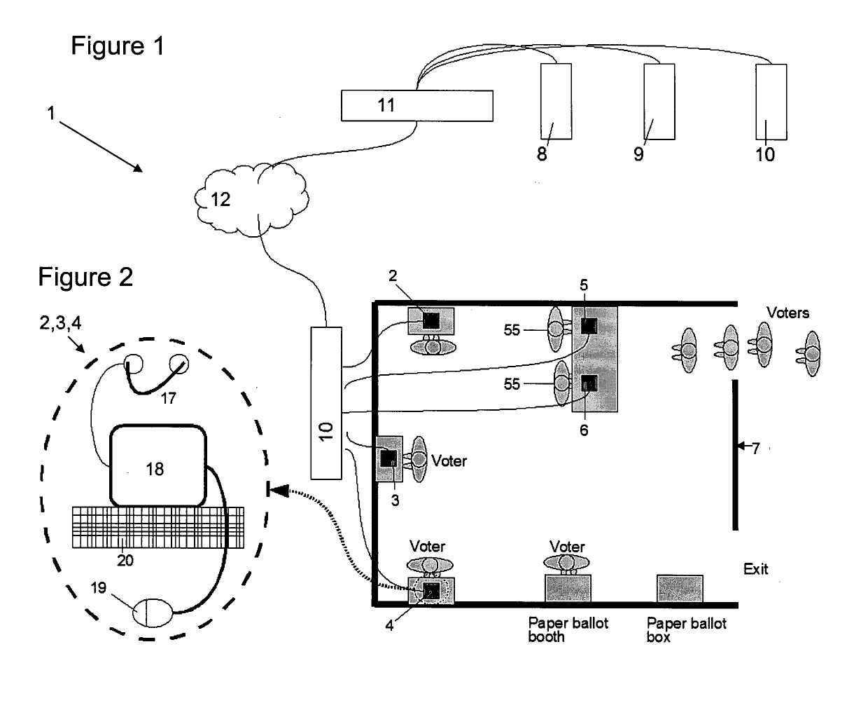

FIG. 1 shows an embodiment of the voting system of the invention;

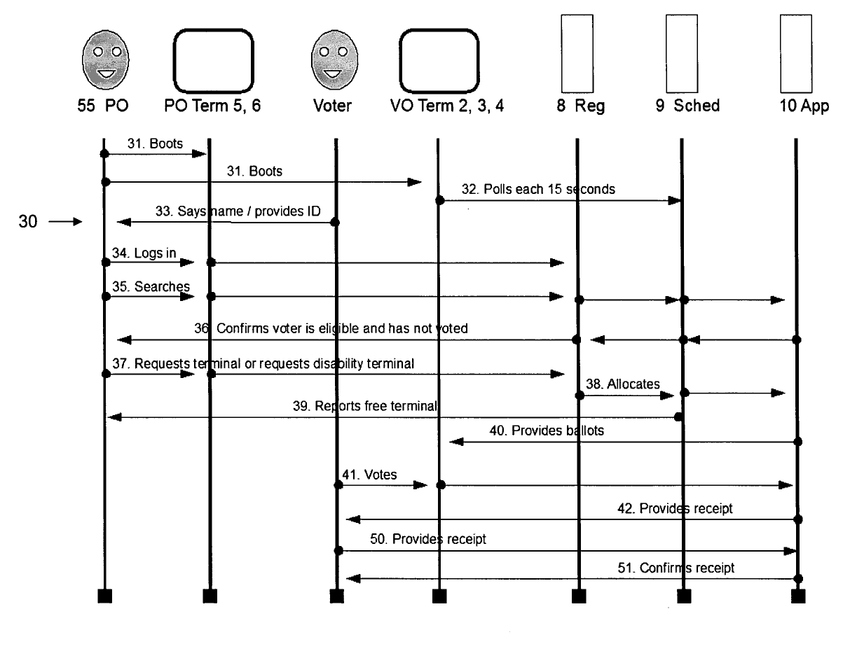

FIG. 2 shows a personal computer used in the system of FIG. 1; and

FIG. 3 shows a flow chart that illustrates an embodiment of the method of operation of the voting system of FIG. 1.

The present invention relates to a supervised electronic networked voting system with the functionality to allow a person to cast their vote at whatever polling station they choose.

An embodiment of a voting system 1 is shown in FIG. 1. The voting system 1 comprises several voting (VO) terminals 2, 3, 4 and Electoral Presiding Officer (PO) terminal terminals 5,6 which are operated by one or more staff 55. Operations to do with set up of equipment and entry of passwords are enacted by at least two PO staff 55 who are tasked to establish the polling station 1 for voters. Three VO terminals 2, 3, 4 and two PO terminals 5,6 are shown, but it will be appreciated that more or less voting terminals or PO terminals may be used.

Typically each VO terminal has a privacy barrier around it to prevent the screen being visible to voters other than the allocated user. FIG. 2 shows VO terminal 2, as configured to allow a disabled person to vote unassisted. This configuration may require a particular position in the polling station with respect to ramps and flooring, lighting and a privacy barrier around the VO terminal. The VO terminals 2, 3, 4 and the PO terminals 5, 6 are located at a polling station represented by enclosure 7.

The voting system further comprises a Register server (Reg) 8 which is arranged to process voting information received from the VO terminals and to determine voter-specific voting options to be presented to each individual voter using one of the electronic voting booths 2, 3, 4. In addition the voting system 1 comprises a Scheduler server (Sched) 9 which is arranged to manage the allocation of VO terminals. An Application server (App) 10 is used to manage the electronic voting session records. The voting booths 2, 3, 4, the PO terminals 5, 6, the App server 10 the Sched server 9, and the Reg server 8 communicate via a communications network which, in this embodiment, includes the public Internet 12. Communications to and from the Internet may be, in many embodiments, via firewalls, switches and other standard security device. In this embodiment, communication is via switch 11. In other embodiments, a private network may be used such as a LAN or an Internet overlay network such as a VPN may be used for communications.

The VO terminals 2, 3, 4 are comprised of personal general purpose computers, FIG. 2 (e.g. Desktop, laptop, tablet, PDA, notebook or similar devices), having a display means 18 comprising a CRT monitor or LCD display, for example, and an input means 20 comprising a keyboard for example. The keyboard 20 may be a conventional QWERTY keyboard, although in this embodiment it is bespoke having buttons that correspond to the information required for a user to cast a vote. Other embodiments may include a mouse or pointing device 19, or Braille-encoded keypad and headphones/microphone 17. Touch screens could be used instead/in addition. The VO terminals 4, 5, 6 also include networking means such as a Wi-Fi wireless (e.g. 80211b or comparable) network card, which, via a wireless router, or gateway provides the means 10 for communication with the Internet. Or a wired connection to the Internet maybe provided.

The VO terminals 2, 3, 4 and PO terminals 5, 6 are “clean” in that they do not have any software preloaded thereon and may in some embodiments be provided without any internal hard disk drives or internal mass storage device. The VO terminals 2, 3, 4 and PO terminals 5,6 thus require a “boot medium” that is inserted into an appropriate reader (not shown) to operate. The boot medium (not shown) is typically provided on an immutable format such as DVDR or CDR and contains software to allow the terminal to communicate with the App 10, Sched 9 or Reg 8 servers. Thus, in this embodiment the software includes only a Linux based operating system, the necessary drivers to allow for communication and a JAVA enabled web browser. This is advantageous as the VO terminals 2, 3, 4 and PO terminals 5,6 only have the minimum amount of software to allow them to provide the voting service therefore significantly reducing the chance of a terminal being reprogrammed or any malicious software being embedded thereon, for example. Provision of this software on immutable media which is securely stored and distributed makes it very difficult for incorrect or malicious software to be introduced on to the VO or PO machines, and makes it easier, and more certain, for an expert to check that there is no malicious software (malware, e.g. Trojan horses) on the computers. This arrangement makes it very simple to replace malfunctioning computers with replacement hardware as the hardware requires no configuration or software installation in advance. The use of general purpose computers allows the system to take advantage of current technology and allows the machines set up for voting to play other roles outside of elections thus reducing the economic burden of ownership and upkeep of the equipment.

In some embodiments, boot media are provided to shut down all peripheral services on a computer before initiating installation of the above-mentioned software (i.e. the minimum required for implementing this invention). This is intended to render the computer in to a tamper-proof form. In one embodiment, disabling USB support and Plug-and-Play (PnP) support prevents the VO terminal being connected to a USB device which could otherwise be used to introduce different software. In another embodiment, the boot medium software shuts down keys on the keyboard, for example to prevent CTRL-ALT-DEL or other special commands which would grant the user access to the operating system or internal services on the PO or VO terminals.

The Sched server 9 is arranged to accept connections from and authenticate each VO terminal 2, 3, 4 in polling station 7 and other polling stations. In one embodiment this is achieved via the provision of a list of machine identities on each boot medium. The PO staff boot a VO machine, select an identity for that machine (such as Voting Machine 1). The PO staff then eject the boot medium, move to the next machine and repeat the process (but this time choose Voting Machine 2). When each VO machine starts its web browser, the VO terminal prompts for the password issued with a digital certificate forming each separate machine identity. The PO staff enter this password.

In this embodiment of the invention each polling station is issued its own boot medium, specific to that polling station. The Sched server detects when a specific machine identity is used more than once. Preparing the PO terminals is performed via a similar process of booting and selecting machine identities from a list of PO machines, however the authenticating server is the Reg 8 server.

This embodiment of the configuration sees the use of a machine identity in each case of voting machine and supervisor machine. Machine identity assigns a different HTTPS client certificate to each machine. The content of this certificate (for example, a unique value set in the Organisational Unit (OU)) forms the basis of the Sched server 9 being able to differentiate between machines and to also form a fully authenticated HTTPS encrypted session. This security makes it difficult for a fraudulent VO or PO machine to be introduced in to the network.

Another embodiment of the invention sees the boot medium take part in a challenge response with the Sched server to determine if the boot medium is a legitimate undamaged copy of the software for a VO or RO terminal. This occurs as follows: the boot medium boots the machine and starts the web browser which is included in the boot software. The browser VO browser queries the Reg server and the VO browser queries the Sched server. The Sched or Reg server replies with a random number. The boot software uses this random number as a seed to create a list of random addresses on its own boot medium. The VO then reads 512 KB or similar blocks from the addresses in this list and processes this read data to determine an MD5 checksum. The checksum is sent back to the Sched or Reg. The Sched and Reg servers host a plurality of the above random numbers and the correct MD5 checksums which should result from the boot medium. Failure of the terminal to return a valid MD5 checksum results in an error message and the boot medium used should be discarded.

When all machines are booted and are assigned identities, the PO staff 55 request a VO terminal 2, 3 or 4 for a voter. This occurs via a request from the PO terminal 5, 6, to the Sched server 9. Each unoccupied VO terminal 2, 3 or 4 regularly polls the Sched server 9 to check for a waiting voter session request. The request from the PO terminal activates a session and the first free voting machine (any of 2, 3, 4) then authenticates the session to the App server which in turn serves the correct ballots for the voter. The App server records results of votes cast and generates receipts for votes that are successfully received. In this embodiment, separate machines or clusters of machines provide the Reg 8, Sched 9, and App 10 service. In some embodiments, these machines may be located at separate physical locations or may be provided by external providers. In some embodiments the App server 10 is a service on a single machine along with Reg server 8 and/or Sched server 9.

The Reg server 8 hosts an electoral roll database containing a list of eligible voters and the region in which they live. The Reg server 8 can also query the App 10 server to determine if a voter has voted and, if they have voted, the means by which they voted e.g. electronic vote or paper vote. The Reg server 8 electoral roll database is kept continuously updated in this embodiment. In some embodiments the electoral roll database information is updated until the day before voting commences (e.g. the day before an election) or it is updated until any other suitable time.

In prior electoral roll processes, electoral roll information is often required to be finalised several weeks before an election in order to allow paper vote forms to be printed and distributed. Advantageously, the voting system of this invention allows for much more up to date electoral role information to be accessed and used during the voting process. Additionally, the invention provides a centralised system which prevents duplicate or multiple voting by the same person in real time. Previously, detection of multiple voting could only take place by manually collating the marked paper (or off-line electronic) registers to find duplicate voters. In countries where voting is anonymous, post-hoc collation of register marks is too late to prevent fraud because voted ballots retain no marks to identify the voter and so no means by which to extract found fraudulent votes.

In some embodiments of this invention, the voter is provided with a choice as to whether they wish to vote electronically or by paper vote. If they choose a paper vote, an updated list of voting options can be printed out for them by the supervisor after the voter has verified her identity. In this way the present invention allows up-to-date information to be used with a parallel running paper voting system. The present invention also allows the electoral role to immediately reflect a voter as having already voted via any channel (poll-place voting, or remote channel such as telephone or Internet, or via the voter having voted on paper at the polling station). The electronic record of paper votes issued can be compared to the number of paper votes counted from the ballot box at the polling station.

The operation of the VO terminals of voting system 1 will now be described with reference to the flow chart shown in FIG. 3 which shows a supervised voting method 30. As part of set-up, the PO staff 55 perform booting step 31 and use the boot media previously described to boot VO and PO terminals. From this time, the VO terminals perform step 32 and continuously (in this embodiment every 15 seconds) poll the Sched server 9. At a step 33, a voter provides identity information to the PO staff 55 in the polling station 7. In the system of this invention, the voter is able to vote at any polling station which is connected to the same communications network as the polling station 7 (i.e. the Internet). In this embodiment the identity information which the voter provides to the supervisor 55 is name and address information. This information is sufficient to identify the voter on the electoral roll. In other embodiments the identity information comprises the voter's name, address, ballot number (e.g. as displayed on a ballot card sent to the voter via post), a PIN number (e.g. sent to the voter by post or email), some electronic token such as a smart card or personal device or any combination of these.

In this embodiment (but not in some other embodiments) the PO staff 55 are also required to verify their identities prior to the PO terminal 5,6 being used or after the PO terminal times out due to inactivity. To this end, a login page is displayed on the PO terminal 5. The PO 55 is required to enter a predetermined password which verifies her identity as a supervisor. The password is transmitted securely (e.g. by SSL connection) to the Reg server 8 which verifies the password. This password is provided in addition to the digital certificate password required at the boot up step 31.

The voter approaches the PO staff 55 who use the PO terminal 5 or 6 to input the voter's name, Register Number or other information at step 35. The PO terminal queries the Reg server 8 at step 35, the replies to which list one or more voter addresses given in reply from Reg. The PO then asks for an address from the voter and chooses this address from possibly several addresses returned from the Reg server. Several addresses may be returned for common surnames, for example. If the PO staff 55 key in a Register Number, on the other hand, we expect a single address to be returned.

If the Voter confirms the address, PO system is used to query (as part of step 35) if the voter is entitled to vote and has not already voted at any other polling station, remotely (via Internet or telephone as the case may be) or on paper. This reply is returned from Sched and App at step 36. If the voter has not voted, the PO can offer the Voter paper or electronic voting. If the voter chooses paper, the PO confirms this with the PO terminal, which records the issue of paper. If the voter asks for an electronic terminal, PO requests this at step 37 and Reg allocates an available terminal via Sched at step 38.

The App server determines some voter-specific voting options which should be presented to the voter at step 40. In this embodiment the voting options comprise a list of possible candidates that the voter can vote for. In different constituencies there will be different electoral candidates and so a voter from one constituency will be able to vote for a different set of candidates compared to a voter from a different constituency. In this way the voting options are voter-specific. The method and system of this invention allow a voter to enter a polling station outside their own constituency but still be presented with voting options relevant to their own constituency. In some embodiments the voter is presented with voting options relevant to their own constituency only. In conjunction with this, the voting system of this invention is supervised by the PO staff 55 which provides extra security and reduces the likelihood of anyone attempting to risk voting fraud (since the voter knows that they are being supervised and that this supervision prevents voter coercion, amongst other practices). This is significantly different to voting via the Internet from an unsupervised terminal (e.g. at home) where a fraudster may feel more confident in attempting fraud unobserved without time constraints and without risk of physical intervention. Supervised polling also makes vote selling very difficult because there is no evidence the voter can provide after the fact to guarantee they have voted the buyer's voting preferences.

At a next step 39, one, and only one, of the unoccupied VO terminals 2, 3, 4 is selected by Sched for the voter to use. Which VO terminal to use is relayed to the voter by the RO staff 55. In an embodiment of the invention, the voter is issued the first available voting machine 2, 3, 4 by its specific number by the Sched server. The polling administrator then advises the voter to walk to that voting machine, which is clearly labelled. If no machine is available the vote processor requests the polling administrator to wait. In another embodiment of the invention, Sched server 9 is able to check which of the booths is not being used since it is able to receive status information from each booth 2, 3, 4. In other embodiments, the supervisor 55 prescribes an electronic voting booth for the voter by checking which of the booths is not being used (e.g. by looking to see if there is anyone in them), and sending this information to the Sched server. In another embodiment of the invention, one particular VO machine (VO terminal two in this embodiment) is set on a high desk to accommodate a wheelchair and this specific terminal can be allocated manually by the PO staff if required.

At a next step 40, the voting booth VO terminal is activated. As an example, consider that voting booth 3 is selected. The voting booth 3 will display the voting options to the voter on its display 18. By prescribing a voting booth for the voter to use, a further security measure is provided since the voter is not able to choose a particular booth and so has no knowledge of which booth he will be using before the booth number is assigned. In addition, only one of the booths 2, 3, 4 is prescribed in this embodiment. Therefore the voter-specific voting options need only be activated at one of the booths. Queuing at the booths is not permitted as is the case with paper voting.

At step 40, the voting booth 3 displays the voting options to the voter. In some embodiments the voting options are presented in more than one language. In some embodiments the voter is requested to choose a preferred language, in which language subsequent information is displayed to the voter. The correct voting options for that voter are then rendered in the chosen language.

In this embodiment the voting options comprise a list of candidates that the voter can vote for. In some embodiments the voter may have the option of reading, viewing, listening to, (or any combination of these), information relating to one or more of the candidates. In other embodiments the voter may be required to read/view/listen to such information, at least in relation to the candidate being voted for before finalising their vote.

At a next step 41, the voter inputs voting information using the input means 17, 19 or 20 at the voting booth 3. At a further step 41, the voting booth sends the voting information to the App server 7. In this embodiment, this step 41 is carried out immediately after the voter has voted, i.e. voting information from a further voter is not obtained before sending this voting information. As a result, the voting booth 3 never has voting information for more than one voter held at any one time, and only while it is switched on. This minimises the possibility of fraud since historical voting information is not kept at the voting booth. Also, if the voting booth is damaged or destroyed then historical voting information will not be lost. If any voting machine among 2, 3, 4 ceases to function, it is simply turned off and replaced. If a voter has not submitted their vote they can approach the supervisor again and be assigned another machine. If the voter has finished voting the replacement machine is immediately ready for assignment to the next voter. If a voter abandons their machine, the voter's voting session times out and the VO terminal again becomes available for subsequent voters. An abandoned session can be resumed at a later time within the polling period.

By storing the vote information remotely, and immediately, the information can be immediately backed up. Compared to the prior electronic voting systems in which electronic votes were stored at an electronic booth until the end of the election process prior to moving the data from the electronic voting booth, this system is much more secure against damage to the voting booth or data during the election. In addition, central aggregation of votes directly from voters allows strong confirmation of the voter's inclusion in the election count, allows stronger perimeter security to be put in place around collected votes and allows direct scrutiny over the arrival of all votes rather than the distributed scrutiny required for votes entering a plurality of individual ballot boxes or machines which may be geographically far apart.

The networked element of the solution also provides a secure, instantaneous form of transport as opposed to the physical transport of voting machine memory cartridges.

In some embodiments, where it is mandatory to vote in an election (e.g. it is mandatory to vote in Australian elections and those in 28 other countries), the electronic records kept via Sched 9 can be used as a guide to who has and who has not voted. If it is necessary, actions can be performed towards the group that has not voted (e.g. sending them a penalty notice) or towards the group that has voted (e.g. sending them confirmation that they have successfully voted) or both.

At a next step 42, the method 30 of this embodiment comprises issuing a receipt to the voter. The receipt takes the form of a code (in this embodiment a 12 digit alpha-numeric code). The receipt does not contain the voter's identity nor the voting choices the voter took. In this embodiment, the receipt can be used subsequently (when votes have been decrypted) to verify that a voter has voted successfully at step 50. In this embodiment this is achieved by the voter logging on to a receipt checking website and entering a “keyword” they have made up as part of their being issued the voting receipt. This “keyword” is not a password but a word the voter was asked to provide during voting that they can easily recall. The keyword is used to tie the receipt to a specific voter. The receipt checking website shows a current receipt code for the voter—this should match the voter's receipt code at step 51 which was provided at the time of the voting. The receipt is generated from the keyword and information contained only in the encrypted vote. If it does match then the vote has been delivered to the authorities who decrypt votes successfully and without tampering, loss or damage. If it does not match then the voter has the ability to report this. As the voter is the only person who knows the “keyword”, they are the only person who can know if their receipt matches and so there is no avenue for this receipt checking service to be replaced on the server with a trojan version that attempts to report receipts.

Various modifications may be made to the present invention without departing from its scope. For example, in some embodiments the PO staff may not be present in person, but via remote means such as may be possible with a PO terminal plus suitable automation or detection means (e.g. a camera).

In another embodiment the voter has been sent by the government a voter identification number (e.g. by post)—a VIN. The voter may have to tell the PO staff that VIN to be allowed to vote. Or the voter may be required to key in their VIN in the voting booth to be authenticated.

1. Supervised voting method for allowing a voter to vote under the 5 supervision of a supervisor at a voting booth at which the voter can vote, the method comprising
the voter providing identity information to the supervisor;
the supervisor verifying the identity of the voter and sending the identity information to a remote polling administrator service, which determines voter specific voting options to be presented to that voter;
the polling administrator service sending details of the voter-specific voting options to the voting booth,
the voting booth displaying the voting options to the voter,
the voting booth receiving voting information from the voter,
the voting booth sending the voting information to a vote processor.

2-28. (canceled)
